(19) United States
(12) Patent Application Publication
(10) Pub. No.: US 2007/0074257 A1
(43) Pub. Date: Mar. 29, 2007

(54) Image forming device and method

(75) Inventor: Toshinori Tamura, Niigata (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/447,916

(22) Filed: Jun. 7, 2006

(30) Foreign Application Priority Data
Sep. 21, 2005 (JP) 2005-274575

(51) Int. Cl. H04N 7/173

(52) U.S. Cl. 725/104

(57) ABSTRACT

An image forming device for forming an image on an image forming medium on which a storage medium is mounted, which comprises a reading portion that reads charging level information from an image forming medium on which a storage medium storing the charging level information of pay content information is mounted, and an image forming controller that allows formation of an image on the image forming medium of the pay content information in a range indicated by the charging level information read by the reading portion.

### CROSS-REFERENCE TO RELATED APPLICATION

This application claims priority under 35 U.S.C. § 119 from Japanese patent application No. 2005-274575, the disclosure of which is incorporated by reference herein.

### BACKGROUND

1. Technical Field

The present invention relates to an image forming device and method for printing out provided information, and more particularly to an image forming device and method that can print pay information on the basis of a value added to an image forming medium.

2. Related Art

Generally, magazines and newspaper can be bought by paying prescribed money, but in a case of pay electronic data, pay information is provided by controlling access to the electronic data. For example, to refer to pay information such as stock price information or particular news information, such information becomes available by previously making a subscription to a vender providing such information and inputting the provided user ID and password to access a page where the pay information can be referred. Otherwise, the pay information can be obtained by executing a prescribed special application provided by the vendor.

At this time, the vendor checks the input user ID and password for their consistency and also identifies the user, who is provided with the pay information, to charge the user for the use.

Thus, it is general to provide pay information by previously making the user to subscribe, identifying the user who buys pay information and charging the user for the information.

Besides, there is also information that is available without charge by making a prescribed operation only. For example, it is allowed to refer to a prescribed file on a Web browser only, and the user who receives the service can execute the permitted operation only. In this case, the file cannot be printed out or stored in a storage device.

But, the user who is an information receiver cannot obtain prescribed information unless the user previously registers as a member or a user or operates a file which is limited to a prescribed operation only. To subscribe, personal information such as a name, a mail address and a credit card number must be input, so that it is not simple to obtain necessary information. And, a vendor that is an information providing source must manage the personal information of the registered user and information about the browsing history, so that a large amount of cost is required for configuration of a system for providing information.

If printout or storage in a storage device cannot be made even when the user operates a file which is allowed to execute a prescribed operation only, its utility value decreases greatly.

There has been known a technique concerning a system which delivers information at cost and provides a charging system capable of properly charging the user has been known.

According to this technique, the charging system is comprised of a charging center and a terminal device, charging point information is stored in the terminal device, and updates are made such that a point value of the purchased information is consumed from the charging point information. And, the charging point information is sent to the charging center with prescribed timing, and charging processing is made by the charging center. Thus, there is provided the charging system that it is not necessary to make the charging processing through communications every time the pay information is input to the terminal device, and a charging processing medium such as a prepaid card is not required.

According to the above-mentioned technique, however, the charging point information is exchanged between the charging center and the terminal device and the charging point information must be kept for every terminal device. And, the use history information of the terminal device is stored in the charging center in view of the transition of the charging point information, and the charging center needs to ensure security and to manage various kinds of information.

### SUMMARY

An aspect of the invention provides an image forming device for forming an image on an image forming medium on which a storage medium is mounted, comprising: a reading portion that reads charging level information from an image forming medium on which a storage medium storing the charging level information of pay content information is mounted; and an image forming controller that allows formation of an image on the image forming medium of the pay content information in a range indicated by the charging level information read by the reading portion.

### BRIEF DESCRIPTION OF THE DRAWINGS

Embodiments of the present invention will be described in detail based on the following figures, wherein:

FIG. 1 is a system structure diagram of a printing system which is configured by applying an image forming device and method according to the invention;

FIG. 2 is a block diagram showing in detail a structure of the information delivery server in the printing system of the invention;

FIG. 3 is a diagram showing in detail a structure of a printer in the printing system of the invention;

FIG. 4 is a diagram showing a selection screen of pay information shown on a screen of a client PC in the printing system of the invention;

FIG. 5 is a sequence diagram showing a process transition of the printing system of the invention;

FIG. 6 is a sequence diagram showing a process sequence in a case where article data is data in a printer file form;

FIG. 7 is a diagram showing another structure example of the printing system configured by applying the image forming device and method of the invention;

FIG. 8 is a sequence diagram showing a process transition according to Example 2 of the printing system of the invention;

FIG. 9 is a diagram showing a third structure example of the printing system configured by applying the printing system and method of the invention;

FIG. 10 is a diagram showing a fourth structure example of the printing system configured by applying the printing system and method of the invention; and

FIG. 11 is a sequence diagram showing a process sequence of Example 3.

### DETAILED DESCRIPTION

Embodiments of an image forming device and method according to the invention will be described in detail with reference to the accompanying figures.

Descriptions will be made with reference to printing paper as an example of an image forming medium but a card may also be used instead of the printing paper.

### EXAMPLE 1

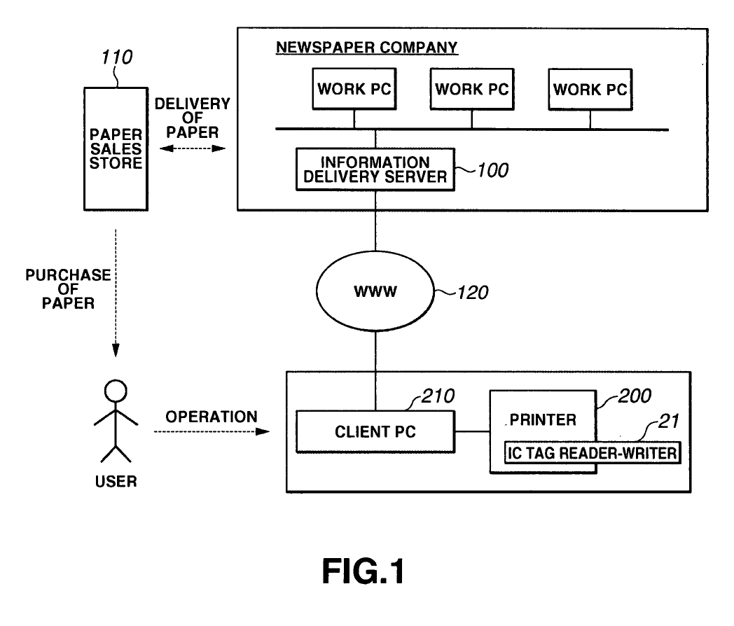

FIG. 1 is a system structure diagram of a printing system which is configured by applying an image forming device and method according to an embodiment of the invention.

In FIG. 1, this printing system comprises an information delivery server 100 which is installed in a newspaper company as an information providing source, a client PC 210 which is operated by a user, and a printer 200 which is connected to the client PC 210 and prints out information provided by the information delivery server 100. Especially, the information delivery server 100 is connected to plural client PCs 210 through internet 120.

Article data having articles prepared by work PCs of a newspaper company computerized are accumulated in a database of the information delivery server 100 which is made open to public by the newspaper company, and a headline screen indicating a list of articles is displayed on the client PC 210 by the information delivery server 100, so that a desired article can be selected for reference. The selected article data is pay information and can be printed out to read by a user who pays a fee in the same manner as in a case of buying a magazine or a newspaper.

The newspaper company delivers printing paper, in which an IC (Integrated Circuit) tag is built, to a paper sales store 110, sells the printing paper to a user who is a pay information receiver, and receives a fee from the user.

The IC tag which is built in the printing paper stores paper information containing at least “charging level information” and “use history information”, and the charging level information is information indicating a charging level which determines a range of limiting the contents of pay information provided. For example, a printing range is determined according to a provided content, a provided amount or a form of printout. The use history information is information indicating whether or not the article of pay information has been printed on printing paper, and if yes, “used” is stored, but if no, “unused” is stored.

As the charging levels of charging level information, for example, level 1, level 2 and level 3 are determined. The newspaper company previously determines “100 yen” “50 yen” and “10 yen” as sales prices corresponding to the level 1, the level 2 and the level 3, respectively. Specifically, the paper sales store 110 sells printing paper, for which the level 1 is determined, at 100 yen per piece, printing paper, for which the level 2 is determined, at 50 yen per piece, and printing paper, for which the level 3 is determined, at 10 yen per piece to get paid for the pay information.

The user can buy the printing paper with the IC tag at the paper sales store 110 and print out the article data provided by the information delivery server 100 on the printing paper.

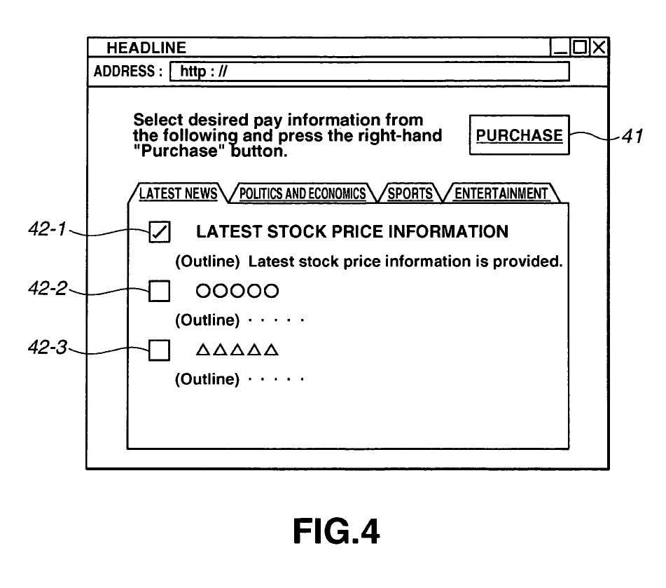

The information delivery server 100 holds the database where computerized article data are stored and provides information by sending article data to the accessed client PC 210. The information delivery server 100 also holds headline data of a headline screen which lists headlines of articles and displays them on the display of the client PC 210 when the articles are referenced from the client PC 210 to allow the user to select an article. An example of the headline screen shown on the client PC 210 is shown in FIG. 4.

When an article to be printed out is selected by the user, the information delivery server 100 demands the selected client PC 210 for paper information of printing paper on which the article data of the selected article is printed and checks that use history information contained in the obtained paper information is “unused”. The information delivery server 100 judges a charging level which is designated by the charging level information contained in the paper information and sends article information corresponding to the charging level to the client PC 210.

For example, in a case where printout is made on printing paper which has a charging level “level 1”, all the selected articles are printed out with highest image quality of the printer, and in a case where printout is made on printing paper which has a charging level “level 3”, printout is made without printing photograph data contained in the articles.

The article data accumulated in the database of the information delivery server 100 can be generated by various applications and can be accumulated in various file types, but the article data to be sent to the client PC 210 is converted into a PDF (Portable Document Format) form or a printer file form which can be printed out directly by the printer.

The client PC 210 selects an article to be printed out on the headline screen from the articles accumulated in the database of the information delivery server 100 and gives a printout instruction to the printer 200 to print out the article data received from the information delivery server 100.

Where the user accesses the information delivery server 100 by means of a Web browser contained in the client PC 210 to display the article headline data and selects an article to be printed out for reference, the information delivery server 100 makes a request for paper information of printing paper on which article data corresponding to the article is to be printed. In response to the request, the client PC 210 reads the paper information from the IC tag of the printing paper which is set on the connected printer and gives the paper information to the information delivery server 100.

When the article data is provided by the information delivery server 100, a printout process is performed to give a print instruction to the printer 200. Together with the print instruction, the paper information is transferred to the printer in order to judge whether or not the paper information obtained when the paper information acquisition request was made from the information delivery server 100 agrees with the paper information of the printing paper on which printout is carried out according to the print instruction, and it is instructed to reread the IC tag of the printing paper.

The printer 200 has an IC tag reader-writer 21 and prints out the article data according to the print instruction from the client PC 210. The IC tag reader-writer 21 reads information from the IC tag added to the printing paper and updates the information contained in the IC tag.

For example, when a print process is performed, use history information stored in the IC tag is updated from “unused” to “used” to prevent overwriting on the used printing paper.

Consistency check is also performed to check whether or not the paper information transmitted to the information delivery server 100 agrees with abstract information of the printing paper on which information is printed.

By configuring as described above, articles provided at cost by the newspaper company can be printed out according to the information in the IC tag added to the printing paper.

Printout can be made based on only the paper information contained in the IC tag, so that pay information can be obtained without remaining the registration of personal information or browsing history.

In the above example, the user selects an article with reference to the headlines based on the headline data held by the information delivery server 100, but it may be configured such that the user can have article abstracts displayed instead of the headlines to select from the abstracts a desired article to read its details, or full texts of articles are displayed to charge only when printout is carried out.

It is configured in the above example that the paper information consistency check is performed by the printer 200, but it may also be configured to perform the consistency check by the client PC 210 by obtaining the paper information of the printing paper by the client PC 210 from the printer 200 immediately before the printout.

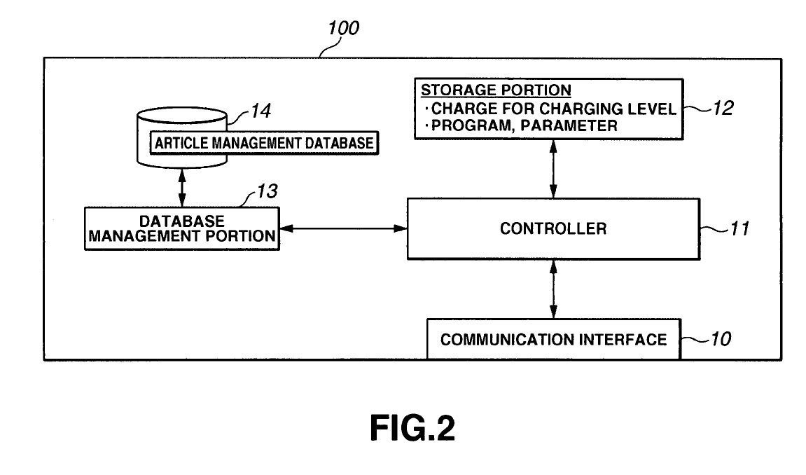

FIG. 2 is a block diagram showing in detail a structure of the information delivery server in the printing system of the invention.

The information delivery server 100 shown in FIG. 2 is comprised of a communication interface 10, a controller 11, a storage portion 12, a database management portion 13 and an article management database 14, and processes in response to a reference request of pay information from the plural client PCs 210.

The communication interface 10 is an interface of a communication line connected through the Internet and establishes communications with the plural client PCs 210 through the Internet and individual nodes of the network in the newspaper company.

The controller 11 is comprised of a CPU (Central Processor Unit) and processes in response to the request for provision of pay information through the communication interface 10.

In response to the request from the client PC for display of the headline screen which shows a list of headlines, the data of the headline screen as shown in FIG. 4 is responded. The user selects an article of buying pay information from the screen shown on the client PC, and in response to the request from the client PC for acquisition of the pay information received by the information delivery server 100, a request for acquisition of paper information of the IC tag which is built in the printing paper on which the pay information is to be printed is made to the client PC.

According to the use history information contained in the paper information obtained from the client PC, it is checked that the printing paper is unused, and a charging level is also checked according to the charging level information.

After the above checking, the article data selected from the article management database 14 through the database management portion 13 is obtained and converted to a prescribed format and sent to the client PC. The prescribed format is, for example, a PDF form, and if the article managed by the article management database 14 is not in the PDF form, it is converted before sending.

Thus, the printer can print out if it corresponds to only a particular format.

The prescribed format may not be a file form such as the PDF, but the article data may be a print file which is written in PDL (Page Description Language). In this case, the printer connected to the client PC obtains information according to the corresponding PDL together with a request for acquisition of paper information, and writes the article data in the obtained PDL.

The storage portion 12 stores various programs for realizing the functions of the information delivery server 100, and such programs are executed to provide the pay information. The storage portion 12 also stores parameter information that is called by these programs.

Besides, the sales price for the charging level of the charging level information stored in the IC tag which is built in the printing paper is stored in correspondence with it. For example, it is managed to correspond a sales price of “100 yen” with the charging level of level 1, a sales price of “50 yen” with the charging level of level 2, and a sales price of “10 yen” with the charging level of level 3.

In addition, article data is temporarily stored at the time of processing by the controller 11.

The database management portion 14 accesses the article data managed by the article management database 15 to perform processing such as addition, updating and deletion. In response to the request for acquisition of article data from the controller 11, the database management portion 14 searches the article management database 15 for the requested article data to get the desired article data.

The article management database 15 stores article data generated by the newspaper company. The article data are stored in various forms.

By configuring as described above, the article data of pay information can be printed on the printing paper according to use history information and charging level information contained in the paper information of the IC tag built in the printing paper.

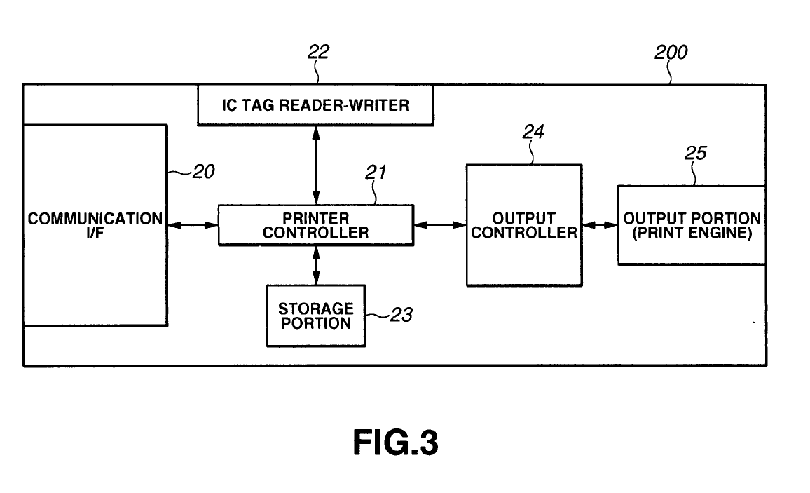

FIG. 3 is a diagram showing in detail a structure of a printer in the printing system of the invention.

In FIG. 3, the printer 200 is comprised of a communication interface 20, a printer controller 21, an IC tag reader-writer 22, a storage portion 23, an output controller 24 and an output portion (print engine) 25, and prints out according to the paper information in the IC tag of the set printing paper.

The communication interface 20 is an interface for communicating with the client PC through a communication line.

The printer controller 21 is a CPU of the printer 200 and controls the request for acquisition of paper information from the client PC and printout. Upon receiving the request for acquisition of paper information, the printer controller 21 instructs the IC tag reader-writer 22 to read paper information of the IC tag and responds the read paper information to the requesting client PC.

Upon accepting the printout request, the printer controller 21 checks whether or not the read paper information and paper information at the time of the printing request agree with each other by comparing them in response to the request for reading paper information. After checking, the printer controller 21 prints out the requested article data and updates the use history information stored in the IC tag from unused to used.

It may be configured to print out the requested article data after updating (rewriting) the use history information of the IC tag from unused to used. It may also be configured to update the use history information from unused to used when a prescribed print amount is printed and then to continue the remaining printing after the updating.

The IC tag reader-writer 22 reads the paper information stored in the IC tag built in the set printing paper according to an instruction from the printer controller 21. The read paper information is temporarily stored in the storage portion 23 and used at the time of printing on the printing paper to check whether or not the printing paper that the paper information is read from the IC tag is same as the paper actually used to print out.

The storage portion 23 stores a program which realizes various functions of the printer and also stores a parameter which is called from the program.

The storage portion 23 temporarily stores the paper information read from the IC tag to judge whether or not the printing paper from which the paper information is read by the printer controller 21 is same as the printing paper on which printing is actually made.

The output controller 24 controls according to the output request from the printer controller 21 to allow the printout of the article data.

The output portion (print engine) 25 performs an article data printing process.

By configuring as described above, an article which is pay information can be printed on the printing paper in which the IC tag is built.

FIG. 4 is a diagram showing a headline screen shown on a display of a client PC in the printing system of the invention.

The headline screen shown in FIG. 4 is a screen to show a list of articles to be bought by users as headlines and configured of, for example, a Web screen which can be shown by a Web browser. The client PC showing the headline screen is operated to select an article which is pay information to be bought.

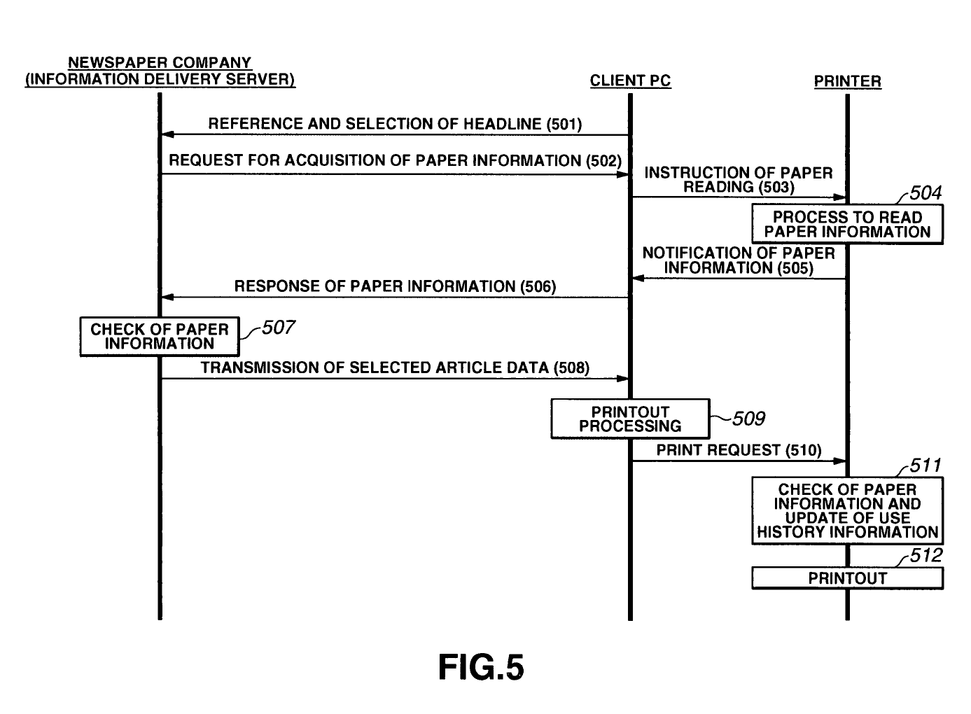

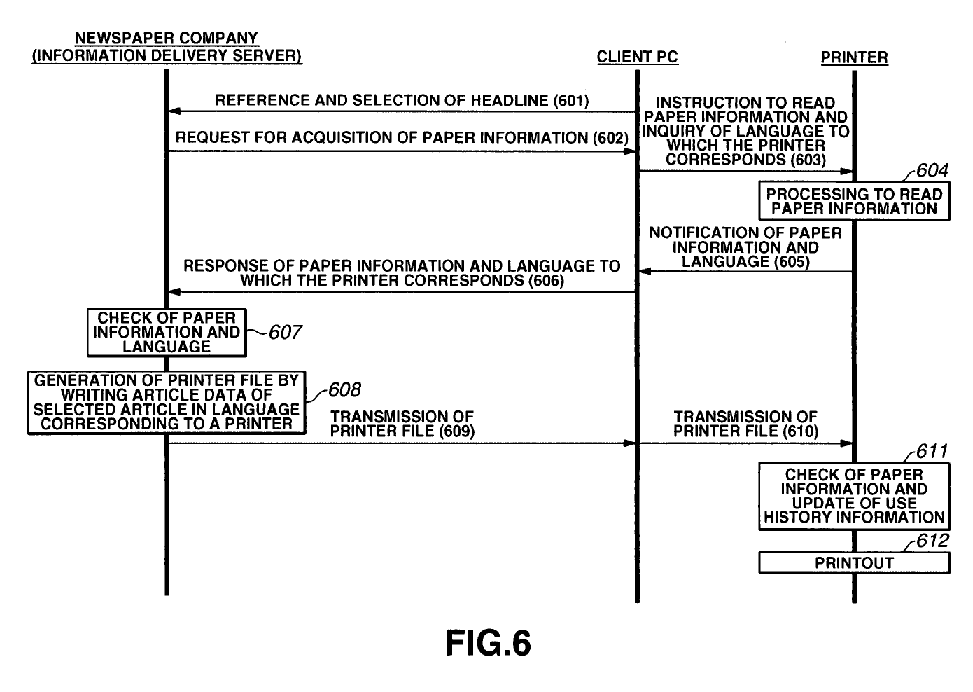

Checkboxes (42-1, 42-2, 42-3 . . . ) disposed in correspondence with articles are checked to select desired articles from the headlines, and a purchase button 41 is pressed. Thus, the process according to the sequences shown in FIG. 5 and FIG. 6 can be performed to purchase (printout) the pay information.

Where the headline screen is a Web screen which can be shown by a Web browser, a link to information related to the article can also be provided. In such a case, the user can access the link destination by selecting the link to obtain and refer to the necessary information.

FIG. 5 is a sequence diagram showing a process transition of the printing system of the invention.

FIG. 5 shows a process sequence of an information delivery server of the newspaper company providing the pay information, the client PC instructing the printout of the pay information, and the printer on which the IC tag reader-writer is mounted to read and write information of the IC tag built in the printing paper.

First, the user operating the client PC buys printing paper with an IC tag and sets it on the printer connected to the client PC. The printing paper can be bought at any paper sales store such as a newspaper company, a newspaper sales agent and a convenience store, and the added IC tag stores at least charging level information and use history information.

The printing paper, to which the IC tag storing the information is added, is set on the printer, the user accesses the information delivery server from the client PC to refer to the headlines of information so as to select an article to be printed (501). When the article is selected, the information delivery server sends to the client PC a request for acquisition of paper information stored in the IC tag of the printing paper on which the article data of the selected article is printed (502).

The client PC having received the request for the paper information instructs the connected printer to read the paper information (503). The printer having received the reading instruction reads by the IC tag reader-writer the paper information stored in the IC tag which is built in the printing paper on which printout is performed (504) and notifies the read paper information to the client PC (505). Subsequently, the client PC sends the paper information in response to the paper information request from the information delivery server (506).

The information delivery server having received the paper information checks the paper information (507). To check the paper information, it is checked that the printing paper used for printing is unused paper according to the use history information. Then, a charging level of the printing paper is checked from the charging level information.

After the above paper information checks are completed, the article data for the selected article is sent to the client PC (508). The client PC having received the article data performs a printout processing (509) and makes a printout request to the printer (510).

For example, in a case where the article data is data in a PDF form, prescribed restriction and processing can be made by the information delivery server, and the article data in the PDF form is opened by the client PC to generate print data, and printing processing to make a printing request to the printer having read the information stored in the IC tag is performed.

The article data may not be in the PDF form but may be data in a printer file form written in PDL which can be printed out directly by the printer. The process sequence in this case is shown in FIG. 6.

The printer having received the printing request compares the paper information being sent together with the printing request with the paper information of the printing paper on which printing is made to check that they agree with each other (511), updates the use history information from “unused” to “used”, and prints out the article data requested to be printed (512).

By comparing the paper information being sent together with the printing request and the paper information of the printing paper on which printing is made, it is checked whether the printing paper has the paper information read by the previous paper information reading process. In other words, it is made possible to print the paper information on the read printing paper without fail.

According to the above-described sequence, the provided pay information can be printed on the printing paper.

FIG. 6 is a sequence diagram showing a process sequence in a case where article data is data in a printer file form.

FIG. 6 is similar to the sequence diagram shown in FIG. 5, so that differences are mainly described. Similar to FIG. 5, FIG. 6 shows a process sequence of an information delivery server, a client PC and a printer.

To get information from the information delivery server by the client PC, a headline screen of article headline data is referred to and an article to be printed (purchased) is selected (601), and a request for acquisition of paper information stored in the IC tag which is built in the printing paper on which the article is printed is made from the information delivery server to the client PC (602).

The client PC to which the request for acquisition of paper information has been made asks the connected printer for the paper information of the IC tag built in the printing paper and a page-description language to which the printer corresponds (603). The printer having received the inquiry reads the paper information from the IC tag of the set printing paper by the IC tag reader-writer (604). The information in the page-description language to which the printer corresponds is noticed together with the read paper information to the client PC (605).

Besides, the client PC sends the paper information and the information in the page-description language to the information delivery server which has sent the acquisition request (606).

The information delivery server which has obtained the paper information and the information in the page-description language checks the charging level information and use history information contained in the obtained paper information and checks that the use history information is “unused” (607).

Subsequently, the article data of the article corresponding to the charging level is written in the page-description language obtained from the printer to generate a printer file in a form which can be printed out directly by the printer (608).

The printer file is sent to the client PC (609), and the client PC passes it to the printer (610).

The printer checks the paper information that is sent from the client PC together with the printer file and updates the use history information from “unused” to “used” (611). If the paper information sent from the client PC agrees with the paper information of the set printing paper, the printer file is printed out (612).

By the above-described sequence, the article data in the printer file form, which can be printed out directly by the printer, can be printed.

### EXAMPLE 2

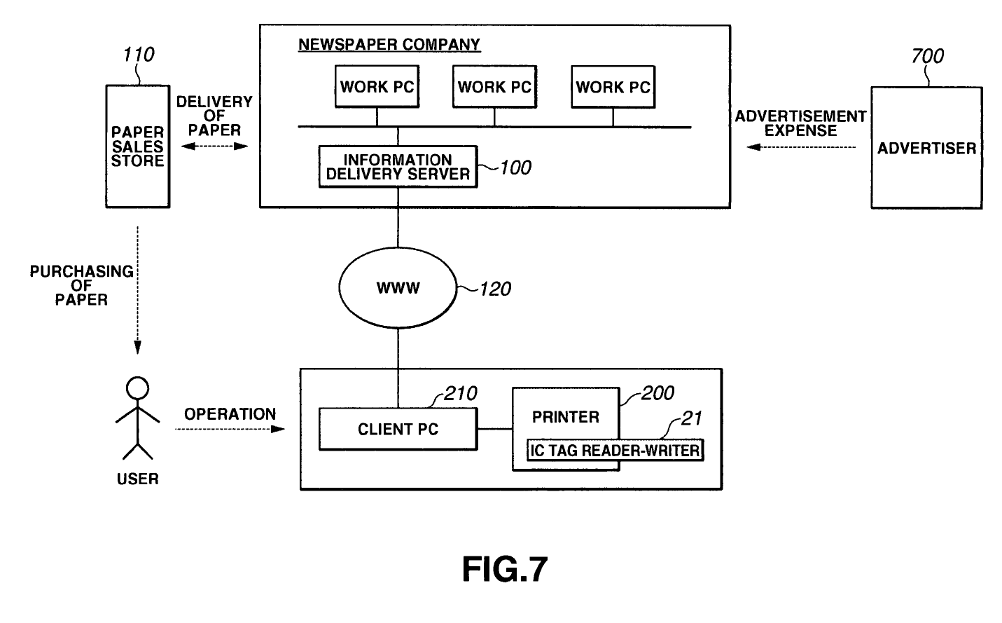

FIG. 7 is a diagram showing a second structure example of the printing system configured by applying the printing system and method of the invention.

FIG. 7 is similar to the structure example shown in FIG. 1, and differences are mainly described.

In FIG. 7, the newspaper company providing articles receives an advertisement insertion request from an advertiser 700 and stores advertisement printing approval information in the IC tag which is built in the printing paper in order to print out an article having the advertisement. The printing paper having the built-in IC tag which stores the advertisement printing approval information is carried to the paper sales store and sold to the users.

The advertisement printing approval information is information indicating whether or not the advertisement requested by the advertiser may be printed together with the articles, and if yes, “advertisement printable” is stored but, if no, “advertisement unprintable” is stored.

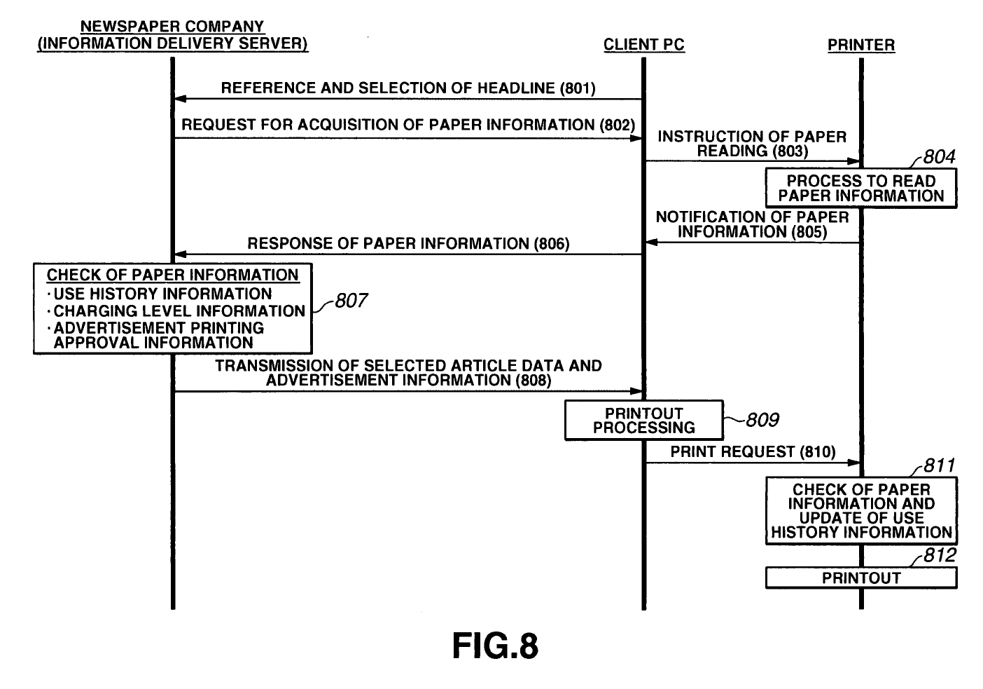

The printing paper having therein the IC tag which stores the paper information containing the advertisement printing approval information set to be advertisement printable is set in the printer 200, and when the article to be bought is selected on the displayed headline screen by accessing the information delivery server 100 from the client PC 210, a process sequence is started as shown in FIG. 8.

The information delivery server 100 holds the article data together with information (hereinafter referred to as “advertising information”) related to the advertisement of which insertion is requested by the advertiser, obtains paper information from the client PC 210 to check it, and sends the article data and the advertising information in the PDF form to the client PC 210.

The client PC 210 requests the printer to print out both the article data and the advertising information in the PDF form received from the information delivery server 100.

By configuring as described above, the advertisement from the advertiser can be printed out together with the article data.

Thus, the newspaper company can sell charging paper at a low price which results from subtracting an advertising expense from an information providing charge.

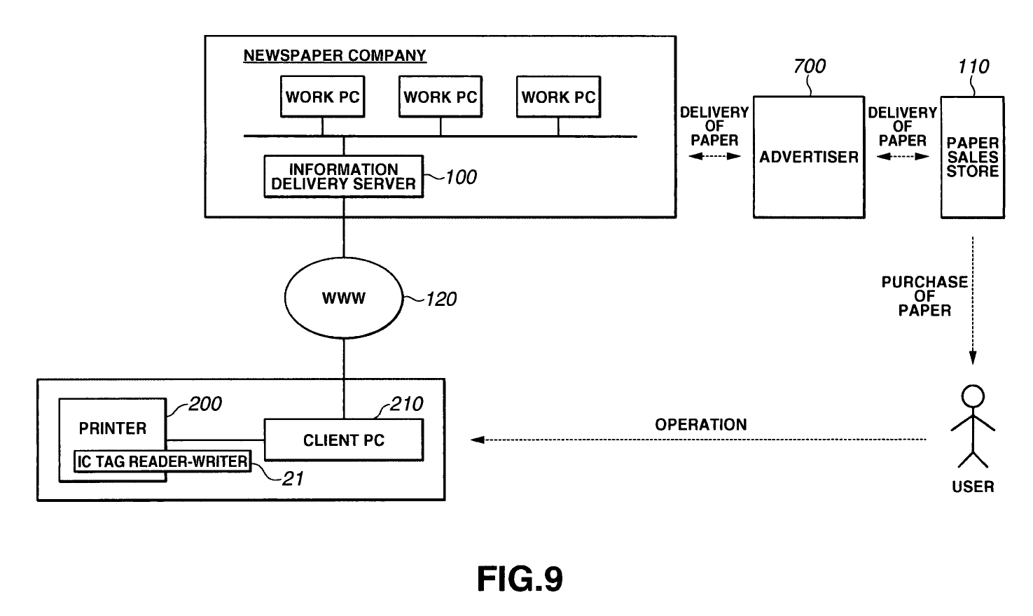

It is configured in FIG. 7 that printing paper which has therein the IC tag storing the advertisement printing approval information for insertion of an advertisement requested by the advertiser 700 is sold to users at the paper sales store. It may also be configured as shown in FIG. 9 that the advertiser sells or distributes printing paper which has the IC tag therein.

Thus, the advertiser can freely handle the paper so that the advertisement is looked.

FIG. 8 is a sequence diagram showing a process transition according to Example 2 of the printing system of the invention.

Similar to FIG. 5, FIG. 8 shows a process sequence of an information delivery server of the newspaper company that is an information providing source of the pay information, a client PC that instructs the printout of the pay information, and a printer having an IC tag reader-writer for reading/writing the information of the IC tag built in the printing paper.

In order to print out the advertisement which is requested by the advertiser, the advertisement printing approval information is stored together with the charging level information and the use history information into the IC tag of the printing paper, and the printing paper having the IC tag is delivered to the paper sales store, where the user buys it.

The printing paper with the IC tag bought by the user is set in the printer, a headline reference request is sent to the information delivery server that is an information providing source, the headline screen as shown in FIG. 4 is displayed on the client PC operated by the user, and then the processing is started. Then, the user selects a desired article from the displayed headline screen (801).

When the article is selected, the information delivery server sends a request for acquisition of the paper information stored in the IC tag of the printing paper, on which the article data of the selected article is printed, to the client PC (802).

The client PC having received the paper information request instructs the connected printer to read the paper information (803). The printer having received the read instruction reads by the IC tag reader-writer the advertisement printing approval information, charging level information and use history information that are the paper information stored in the IC tag built in the printing paper to be printed out (804), and notifies the read paper information to the client PC (805). Subsequently, the client PC sends the paper information read by the printer as a response to the paper information request from the information delivery server (806).

The information delivery server having received the paper information checks the paper information (807). To check the paper information, it is first checked from the use history information that the printing paper is unused paper, and then the charging level of the printing paper is checked from the charging level information. Then, it is checked that the advertisement printing approval information is advertisement printable.

Where the advertisement printing approval information is advertisement printable, the advertising information is sent together with the article data of the selected article to the client PC (808). And, the client PC having received the article data containing the advertising information performs the printout processing (809) and makes a printing request to the printer (810).

The printing request contains the paper information read by the printer, and the printer having received the printing request compares the paper information with the paper information of the printing paper used for printing to check that they agree with each other (811), updates the use history information from “unused” to “used” and prints out the printing requested article data and the advertising information (812).

According to the sequence described above, the advertising information requested by the advertiser can be printed out together with the article data.

It is configured to manage the article data and the advertising information separately by the information delivery server 100, but it may be configured to manage with the advertising information embedded in the article data.

In Example 2 described above, it is configured that the printout is performed by sending to the client PC the advertising information and the article data which are managed by the information delivery server 100 according to the advertisement printing approval information stored in the IC tag. But, it may also be configured that the advertising information is previously contained in the IC tag, taken out at the time of printing by the printer 200 and printed together with the article data.

In other words, the advertising information is overlaid at a prescribed position of the article data and printed out.

### EXAMPLE 3

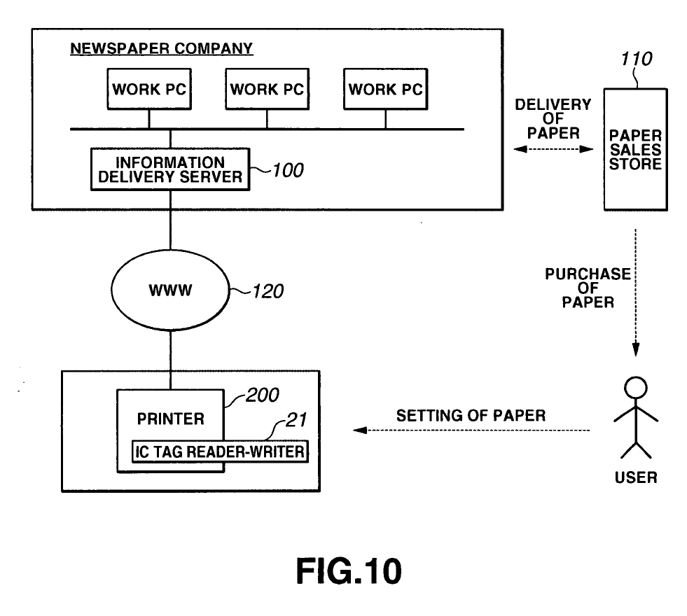

FIG. 10 is a diagram showing a fourth structure example of the printing system configured by applying the printing system and method of the invention.

FIG. 10 is also similar to FIG. 1 and FIG. 7, so that differences are mainly described.

In FIG. 10, printing paper having therein the IC tag which stores the charging level information and the use history information is bought by the user at the paper sales store 110, and set on the printer 200 which can be connected to a network.

Automatic delivery contract of particular pay information is previously closed between the newspaper company and the user, and article data transmitted from the information delivery server 100 is received and automatically printed by the printer 200.

The information delivery server 100 stores data indicating the contents of the contract with the user, for example, data about automatic delivery of the latest news information once a day, and stores identification information for identifying the printer 200 and a network address as its destination address.

For example, in a case where the information delivery server 100 and the printer 200 are mutually connected by Ethernet (registered trademark), a MAC (Media Access Control) address is registered as the identification information, and an IP (Internet Protocol) address is registered as the network address.

Thus, the printer 200 can be identified uniquely on the network, and information previously designated can be delivered to the printer 200.

It is also judged whether or not the prescribed conditions are satisfied according to the paper information obtained from the IC tag of the printing paper set in the printer 200, and if satisfied, the prescribed article data is transmitted.

The printer 200 is a printer, which can realize communications with the information delivery server 100, e.g., a network printer. It directly prints out the received article data, such as the latest news.

The printer 200 also responds to the request from the information delivery server 100. For example, where the information delivery server 100 makes a request for acquisition of paper information, the printer 200 reads paper information from the IC tag in the set printing paper and responds to the information delivery server 100.

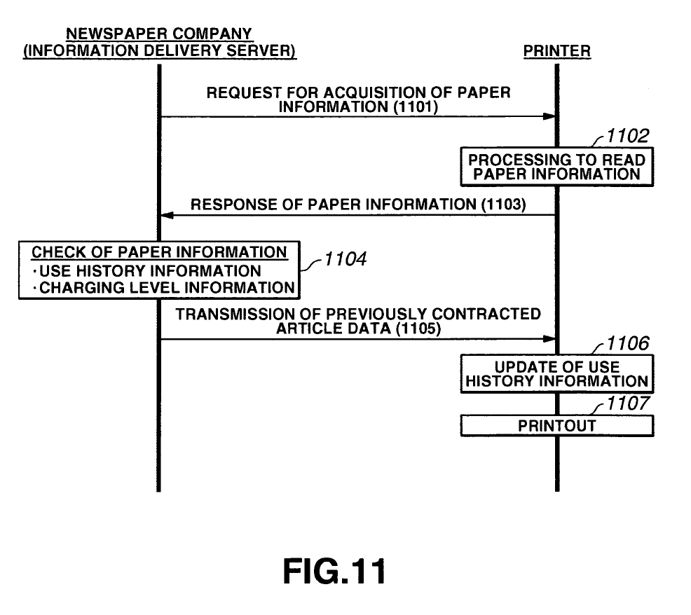

A sequence diagram showing a process transition at that time is shown in FIG. 11.

FIG. 11 is a sequence diagram showing a process sequence of Example 3.

In FIG. 11, when it becomes prescribed time based on the contractual coverage, connection check is made from the information processing server to the printer, and when it is checked that mutual communications can be made, processing is started, and a request for acquisition of paper information is made from the information delivery server to the printer (1101). The printer having received the request for acquisition of the paper information reads paper information from the IC tag of the set printing paper by the IC tag reader-writer (1102) and responds to the information delivery server (1103).

The information delivery server having received the paper information checks according to the use history information contained in the obtained paper information that the paper is unused one and also checks the charging level according to the charging level information (1104).

After the paper information is checked, the previously contracted article data is delivered to the printer (1105), and the printer having received the article data updates the use history information from unused to used (1106) and prints out the article data (1107).

According to the above sequence, particular information can be bought as if it is delivered by newspaper delivery or the like without requiring a computer such as a client PC.

By the processing described above, the printing system of the invention can print out an article which is pay information provided by the newspaper company on the printing paper in which the IC tag is embedded.

Thus, the user can refer to (buy) an article of necessary pay information when the user needs it without inputting personal information.

Therefore, it is expected by applying the present invention that there is an effect of enabling to provide information with high security assured because it is not necessary to resister personal information and no browsing history remains.

The present invention is applicable to a system which provides pay information, and particularly useful for provision by printing out the pay information according to information stored in the IC tag added to the image forming medium.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling other skilled in the art to understand the invention for various embodiments and with the various modifications as are suited to the particular use contemplated. It is intended that the scope of the invention be defined by the following claims and their equivalents.

What is claimed is:

1. An image forming device for forming an image on an image forming medium on which a storage medium is mounted, comprising:
a reading portion that reads charging level information from an image forming medium on which a storage medium storing the charging level information of pay content information is mounted; and
an image forming controller that allows formation of an image on the image forming medium of the pay content information in a range indicated by the charging level information read by the reading portion.

2. The image forming device according to claim 1, wherein the pay content information is information obtained through the Internet from a content server that manages prescribed pay content information.

3. The image forming device according to claim 1, wherein the pay content information is information obtained through the Internet by a user terminal from a content server that manages prescribed pay content information,.

4. The image forming device according to claim 1, wherein the charging level information restricts at least one range of a content, an amount and a printing form of the pay content information.

5. The image forming device according to claim 2, wherein the charging level information restricts at least one range of a content, an amount and a printing form of the pay content information.

6. The image forming device according to claim 3, wherein the charging level information restricts at least one range of a content, an amount and a printing form of the pay content information.

7. The image forming device according to claim 1, further comprising:
a charging level information rewriting portion that rewrites to invalidate the charging level information stored in the storage medium by forming the image on the image forming medium by the image formation controller.

8. The image forming device according to claim 2, further comprising:
a charging level information rewriting portion that rewrites to invalidate the charging level information stored in the storage medium by forming the image on the image forming medium by the image formation controller.

9. The image forming device according to claim 3, further comprising:
a charging level information rewriting portion that rewrites to invalidate the charging level information stored in the storage medium by forming the image on the image forming medium by the image formation controller.

10. The image forming device according to claim 4, further comprising:
a charging level information rewriting portion that rewrites to invalidate the charging level information stored in the storage medium by forming the image on the image forming medium by the image formation controller.

11. The image forming device according to claim 5, further comprising:
a charging level information rewriting portion that rewrites to invalidate the charging level information stored in the storage medium by forming the image on the image forming medium by the image formation controller.

12. The image forming device according to claim 6, further comprising: a charging level information rewriting portion that rewrites to invalidate the charging level information stored in the storage medium by forming the image on the image forming medium by the image formation controller.

13. An image forming method to form an image on an image forming medium with a storage medium mounted thereon, comprising:
reading charging level information from a storage medium, that stores charging level information of pay content information mounted on the image forming medium, by a reading portion;
allowing the formation of an image on the image forming medium of the pay content information in a range indicated by the charging level information read by the reading portion by an image formation controller; and
rewriting to invalidate the charging level information stored in the storage medium by forming the image on the image forming medium by the image formation controller.
